(19) United States
(12) Patent Application Publication
(10) Pub. No.: US 2025/0279087 A1
(43) Pub. Date: Sep. 4, 2025

(54) SPEECH-TEXT PROMPTING FOR SPEECH TASKS

(71) Applicant: Google LLC, Mountain View, CA (US)

(72) Inventors: Kyle Scott Kastner, Waltham, MA (US); Quan Wang, Hoboken, NJ (US); Gary Wang, Mountain View, CA (US); Isaac Elias, Mountain View, CA (US); Andrew Rosenberg, Brooklyn, NY (US); Bhuvana Ramabhadran, Mt. Kisco, NY (US); Pedro J. Moreno Mengibar, Jersey City, NJ (US); Alex Park, Mountain View, CA (US); Kurt Edward Partridge, San Francisco, CA (US); Parisa Haghani, Atlanta, GA (US); Rohan Agrawal, Brooklyn, NY (US); Neeraj Gaur, Jersey City, NJ (US); Jae Yeun Yoon, Mountain View, CA (US); Byungha Chun, Tokyo (JP); Fadi Biadsy, Mountain View, CA (US)

(73) Assignee: Google LLC, Mountain View, CA (US)

(21) Appl. No.: 19/053,399

(22) Filed: Feb. 13, 2025

Related U.S. Application Data
(60) Provisional application No. 63/559,458, filed on Feb. 29, 2024.

(51) Int. Cl. G10L 13/08; G10L 13/027; G10L 17/02; G10L 17/04

(52) U.S. Cl. CPC G10L 13/08; G10L 13/027; G10L 17/02; G10L 17/04

(57) ABSTRACT

A method includes receiving a reference utterance and an input text utterance. The reference utterance includes a plurality of terms spoken by a reference speaker and the input text sequence includes a corresponding transcript for each of the plurality of terms spoken by the reference speaker. The method includes obtaining a speaker embedding characterizing speaker characteristics of the reference speaker that spoke a plurality of terms. The method includes generating a replacement input text sequence by replacing the corresponding transcript of a respective one of the plurality of terms with a replacement transcript corresponding to a different term not included in the reference utterance. The method includes generating, using a text-to-speech (TTS) model conditioned on the reference utterance and the speaker embedding, resynthesized speech based on the replacement input text sequence in a voice of the reference speaker.

### CROSS REFERENCE TO RELATED APPLICATIONS

This U.S. patent application claims priority under 35 U.S.C. § 119(e) to U.S. Provisional Application 63/559,458, filed on Feb. 29, 2024. The disclosure of this prior application is considered part of the disclosure of this application and is hereby incorporated by reference in its entirety.

### TECHNICAL FIELD

This disclosure relates to speech-text prompting for speech tasks.

### BACKGROUND

Automatic speech recognition (ASR) models have demonstrated remarkable progress in recent years, yet the performance of ASR models remains heavily dependent on the availability of large, diverse, and high-quality training datasets. While text-to-speech (TTS) models offer a potential solution by generating synthetic speech data, the reliance on TTS for training data introduces additional limitations. In particular, current TTS technologies, while capable of producing perceptually realistic speech, often struggle to capture the full spectrum of natural human speech variability including nuances in accent, intonation, speaking style, and background noise. Consequently, ASR models trained primarily on TTS-generated data may exhibit reduced robustness and accuracy when exposed to real-world speech, particularly in challenging acoustic environments or when processing speech from diverse populations. The deficiency in training data diversity and real-world representation underscores the ongoing need for improved methods of data augmentation and training strategies to enhance the performance and generalizability of ASR systems.

### SUMMARY

One aspect of the disclosure provides a computer-implemented method executed on data processing hardware that causes the data processing hardware to perform operations for speech-text prompting for speech tasks. The operations include receiving a reference utterance and an input text sequence. The reference utterance includes a plurality of terms spoken by a reference speaker and the input text sequence includes a corresponding transcript for each of the plurality of terms spoken by the reference speaker. The operations include obtaining a speaker embedding characterizing speaker characteristics of the reference speaker that spoke the plurality of terms. The operations include generating a replacement input text sequence by replacing the corresponding transcript of a respective one of the plurality of terms with a replacement transcript corresponding to a different term not included in the reference utterance. The operations also include generating, using a text-to-speech (TTS) model conditioned on the reference utterance and the speaker embedding, resynthesized speech based on the replacement input text sequence in a voice of the reference speaker.

Implementations of the disclosure may include one or more of the following optional features. In some implementations, the operations further include: receiving an audio signal including one or more other terms spoken by a different speaker; generating, using a voice cloning model, a voice cloned reference utterance based on the reference utterance and the audio signal; and generating, using the TTS further conditioned on the voice cloned reference utterance, voice cloned resynthesized speech based on the replacement input text sequence. The voice cloned reference utterance includes synthesized speech corresponding to the input text sequence in a voice of the different speaker. The voice cloned resynthesized speech including synthesized speech corresponding to the replacement input text sequence in the voice of the different speaker. In some examples, the respective one of the plurality of terms includes a first hotword and the different term includes a second hotword different than the first hotword. In these examples, the operations may further include training a hotword model on the resynthesized speech.

The operations may further include training a speech recognition model on the reference utterance paired with the input text sequence and the resynthesized speech paired with the replacement input text sequence. The different term may include a speech disfluency term. In some implementations, the different term is sampled from a different speech domain than a speech domain associated with the reference utterance. In some examples, the operations further include post-processing the resynthesized speech based on the reference utterance to preserve audio from the reference utterance for terms included in the resynthesized speech and the reference utterance. In these examples, post-processing the resynthesized speech includes at least one of cross-fading, force alignment, or dynamic time warping.

The operations may further include modifying the replacement transcript of the different term from the replacement input text sequence, generating an updated replacement input text sequence by replacing the replacement transcript with the modified replacement transcript, and generating, using the TTS model conditioned on the reference utterance and the speaker embedding, additional resynthesized speech based on the updated replacement input text sequence in the voice of the reference speaker. Here, modifying the replacement transcript of the different term from the replacement input text sequence includes at least one of modifying syllables of the replacement transcript, modifying punctuation of the replacement transcript, or inserting a speech disfluency into the replacement transcript. In some implementations, the operations further include generating an augmented speaker embedding that augments at least one of the speaker characteristics of the reference speaker that spoke the plurality of terms and generating, using the TTS model further conditioned on the augmented speaker embedding, additional resynthesized speech including synthesized speech that corresponds to the replacement input text sequence in the voice of the reference speaker with the augmented at least one of the speaker characteristics.

Another aspect of the disclosure provides a system that includes data processing hardware and memory hardware storing instructions that when executed on the data processing hardware causes the data processing hardware to perform operations. The operations include receiving a reference utterance and an input text sequence. The reference utterance includes a plurality of terms spoken by a reference speaker and the input text sequence includes a corresponding transcript for each of the plurality of terms spoken by the reference speaker. The operations include obtaining a speaker embedding characterizing speaker characteristics of the reference speaker that spoke the plurality of terms. The operations include generating a replacement input text sequence by replacing the corresponding transcript of a respective one of the plurality of terms with a replacement transcript corresponding to a different term not included in the reference utterance. The operations also include generating, using a text-to-speech (TTS) model conditioned on the reference utterance and the speaker embedding, resynthesized speech based on the replacement input text sequence in a voice of the reference speaker.

Implementations of the disclosure may include one or more of the following optional features. In some implementations, the operations further include: receiving an audio signal including one or more other terms spoken by a different speaker; generating, using a voice cloning model, a voice cloned reference utterance based on the reference utterance and the audio signal; and generating, using the TTS further conditioned on the voice cloned reference utterance, voice cloned resynthesized speech based on the replacement input text sequence. The voice cloned reference utterance includes synthesized speech corresponding to the input text sequence in a voice of the different speaker. The voice cloned resynthesized speech including synthesized speech corresponding to the replacement input text sequence in the voice of the different speaker. In some examples, the respective one of the plurality of terms includes a first hotword and the different term includes a second hotword different than the first hotword. In these examples, the operations may further include training a hotword model on the resynthesized speech.

The operations may further include training a speech recognition model on the reference utterance paired with the input text sequence and the resynthesized speech paired with the replacement input text sequence. The different term may include a speech disfluency term. In some implementations, the different term is sampled from a different speech domain than a speech domain associated with the reference utterance. In some examples, the operations further include post-processing the resynthesized speech based on the reference utterance to preserve audio from the reference utterance for terms included in the resynthesized speech and the reference utterance. In these examples, post-processing the resynthesized speech includes at least one of cross-fading, force alignment, or dynamic time warping.

The operations may further include modifying the replacement transcript of the different term from the replacement input text sequence, generating an updated replacement input text sequence by replacing the replacement transcript with the modified replacement transcript, and generating, using the TTS model conditioned on the reference utterance and the speaker embedding, additional resynthesized speech based on the updated replacement input text sequence in the voice of the reference speaker. Here, modifying the replacement transcript of the different term from the replacement input text sequence includes at least one of modifying syllables of the replacement transcript, modifying punctuation of the replacement transcript, or inserting a speech disfluency into the replacement transcript. In some implementations, the operations further include generating an augmented speaker embedding that augments at least one of the speaker characteristics of the reference speaker that spoke the plurality of terms and generating, using the TTS model further conditioned on the augmented speaker embedding, additional resynthesized speech including synthesized speech that corresponds to the replacement input text sequence in the voice of the reference speaker with the augmented at least one of the speaker characteristics.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of an example automatic speech recognition model.

FIG. 3 is a schematic view of an example speech synthesis process.

FIG. 4 is a schematic view of an example training process.

FIG. 5 is a flowchart of an example arrangement of operations for a computer-implemented for speech-text prompting for speech tasks.

FIG. 6 is a schematic view of an example computing device that may be used to implement the systems and methods described herein.

Like reference symbols in the various drawings indicate like elements.

### DETAILED DESCRIPTION

Automatic speech recognition (ASR) systems have become increasingly prevalent in various applications, from voice assistants and dictation applications to automated customer service and accessibility tools. The performance of these ASR systems, however, is fundamentally tied to the availability of robust and representative training data. To that end, ASR models are trained on a vast corpora of transcribed audio representing a wide range of speakers, accents, speaking styles, and acoustic conditions. Yet, creating such comprehensive datasets is a significant challenge. Collecting and transcribing real-world speech is expensive, time-consuming, and often raises privacy concerns. Moreover, certain speech patterns, such as those from specific demographic groups or those including rare words or phrases, may be underrepresented in existing datasets, leading to performance biases and reduced accuracy for these populations.

Text-to-speech (TTS) systems offer a potential avenue for addressing data scarcity by generating synthetic speech data. TTS systems generate synthetic speech from text, effectively expanding the training data available for ASR models. While advancements in TTS have yielded impressive results in terms of speech naturalness and intelligibility, relying solely on TTS generated data presents its own set of challenges. Current TTS models, despite their sophistication, often struggle to capture the full spectrum of human speech variability. Subtleties in pronunciation, intonation, speaking rate, and vocal timbre, which are important for accurate ASR, may be lost or simplified in synthetic speech. Moreover, TTS systems may introduce artifacts or biases that are then propagated into the ASR model, negatively impacting performance on real-world speech.

For example, a TTS system trained primarily on formal, scripted language may produce synthetic speech that lacks the disfluencies and conversational nuances present in everyday speech. Consequently, ASR models trained predominantly on such data may exhibit reduced robustness when encountering spontaneous speech in noisy or informal settings. This discrepancy between synthetic and real-world speech underscores the critical need for improved training data strategies to bridge the gap between the capabilities of current TTS technologies and the demands of robust and accurate ASR systems.

Accordingly, implementations herein are directed towards a speech resynthesis process. The speech resynthesis process includes receiving a reference utterance and an input text sequence. The reference utterance includes a plurality of terms spoken by a reference speaker and the input text sequence includes a corresponding transcript for each of the plurality of terms spoken by the reference speaker. The speech resynthesis process includes obtaining a speaker embedding characterizing speaker characteristics of the reference speaker that spoke the plurality of terms. The speech resynthesis process includes generating a replacement input text sequence by replacing the corresponding transcript of a respective one of the plurality of terms with a replacement transcript corresponding to a different term not included in the reference utterance. The speech resynthesis process includes generating, using a text-to-speech (TTS) model conditioned on the reference utterance and the speaker embedding, resynthesized speech based on the replacement input text sequence in a voice of the reference speaker.

Advantageously, a training process may use the resynthesized speech generated by the speech resynthesis process to train an ASR model. This training process addresses the limitations of current ASR training data by generating synthetic speech that more closely mimics real-world speech patterns and speaker variability. By leveraging a reference utterance and the corresponding transcript, the training process extracts a speaker embedding that captures the unique vocal characteristics of a reference speaker. The training process conditions a TTS model on the reference utterance and the speaker embedding, ensuring that newly generated speech maintains the voice and speaking style of the reference speaker. Notably, the training process goes beyond simply generating speech from existing transcripts. That is, the training process introduces variations by replacing words within the original transcript with new words, creating novel sentences while preserving the voice of the speaker. This process generates synthetic speech data that is both diverse in content and consistent in speaker characteristics, effectively expanding the training data for ASR models with realistic variations in vocabulary and sentence structure, all while anchored to the voice profile of a real speaker. This allows ASR models to be trained on a richer and more representative dataset, leading to improved robustness and accuracy when processing real-world speech, especially from diverse speakers and in varied acoustic environments.

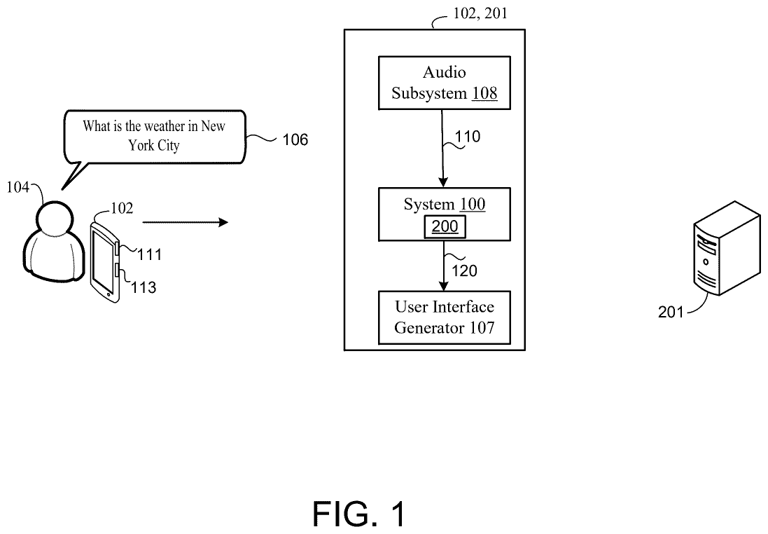

FIG. 1 illustrates an example system 100 implementing an automated speech recognition (ASR) model 200 that resides on a user device 102 of a user 104 and/or on a remote computing device 201 (e.g., one or more servers of a distributed system executing in a cloud-computing environment) in communication with the user device 102. Although the user device 102 is depicted as a mobile computing device (e.g., a smart phone), the user device 102 may correspond to any type of computing device such as, without limitation, a tablet device, a laptop/desktop computer, a wearable device, a digital assistant device, a smart speaker/display, a smart appliance, an automotive infotainment system, or an Internet-of-Things (IoT) device, and is equipped with data processing hardware 111 and memory hardware 113.

The user device 102 includes an audio subsystem 108 configured to receive an utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR system 100. In the example shown, the user 10 speaks a respective utterance 106 in a natural language of English for the phrase “What is the weather in New York City?” and the audio subsystem 108 converts the utterance 106 into corresponding acoustic frames 110 for input to the ASR system 100. Thereafter, the ASR model 200 receives, as input, the acoustic frames 110 corresponding to the utterance 106, and generates/predicts, as output, a corresponding transcription 120 (e.g., recognition result/hypothesis) of the utterance 106. In the example shown, the user device 102 and/or the remote computing device 201 also execute a user interface generator 107 configured to present a representation of the transcription 120 of the utterance 106 to the user 104 of the user device 102. In some configurations, the transcription 120 output from the ASR system 100 is processed, e.g., by a natural language understanding (NLU) module executing on the user device 102 or the remote computing device 201, to execute a user command. Additionally or alternatively, a TTS model (executing on any combination of the user device 102 or the remote computing device 201) may convert the transcription 120 into synthesized speech for audible output by the audio subsystem 108 or another device. For instance, the original utterance 106 may correspond to a message the user 104 is sending to a friend in which the transcription 120 is converted to synthesized speech for audible output to the friend to listen to the message conveyed in the original utterance 106.

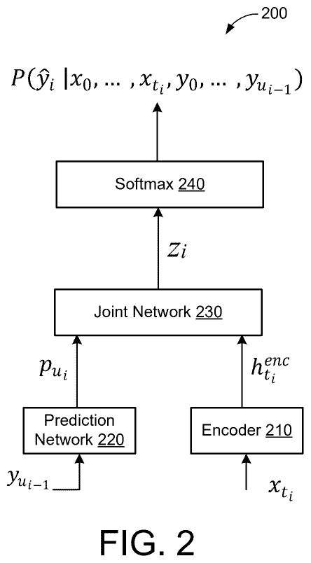

Referring to FIG. 2, in some examples, the ASR model 200 includes a Recurrent Neural Network-Transducer (RNN-T) model architecture which adheres to latency constraints associated with interactive applications. The use of the RNN-T model architecture is exemplary, and the ASR model 200 may include other architectures such as transformer-transducer and conformer-transducer model architectures among others. The RNN-T model architecture provides a small computation footprint and utilizes less memory requirements than conventional ASR architectures, making the RNN-T model architecture suitable for performing speech entirely on the user device 102 (e.g., no communication with a remote server is required). The RNN-T model architecture of the ASR model 200 includes an encoder network 210, a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder network 210 reads a sequence of d-dimensional feature vectors (e.g., acoustic frames 110 (FIG. 1) x=(x₁, x₂, . . . , x_{T}), where xₜ∈ [symbol] _{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{_{i−1}}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 24-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the ASR model 200 at the corresponding output step. In this manner, the RNN-T model architecture of the ASR model 200 does not make a conditional independence assumption, rather the prediction of each symbol is conditioned not only on the acoustics but also on the sequence of labels output so far. The ASR model 200 does assume an output symbol is independent of future acoustic frames 110, which allows the RNN-T model architecture of the ASR model 200 to be employed in a streaming fashion.

In some examples, the encoder network (i.e., audio encoder) 210 of the ASR model 200 includes a stack of self-attention layers/blocks, such as conformer blocks. Here, each conformer block includes a series of multi-headed self-attention, depth wise convolution and feed-forward layers. The prediction network 220 may have two 2,048-dimensional LSTM layers, each of which is also followed by a 440-dimensional projection layer. Alternatively, the prediction network 220 may include a stack of transformer or conformer blocks, or an embedding look-up table in lieu of LSTM layers. Finally, the joint network 230 may also have 440 hidden units. The Softmax layer 240 may be composed of a unified word piece or grapheme set that is generated using all unique word pieces or graphemes in a plurality of training data sets.

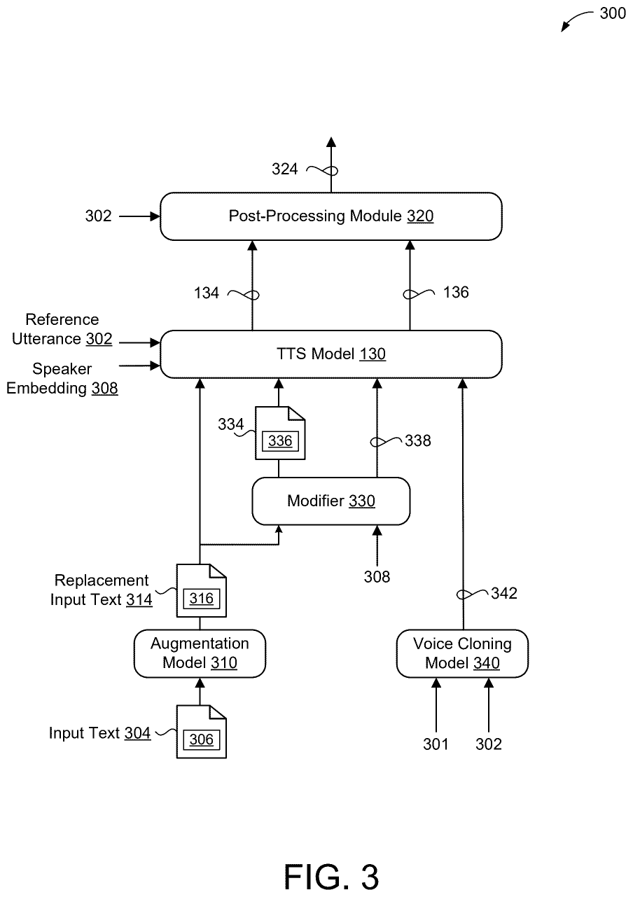

FIG. 3 illustrates a speech resynthesis process 300 that implements an augmentation model 310, a post-processing module 320, a modifier 330, a voice cloning model 340, and a TTS model 130. The speech resynthesis process 300 obtains a plurality of reference utterances 302 and a plurality of input text sequences 304. Each reference utterance 302 is a segment of speech that includes a plurality of terms spoken by a reference speaker. For example, the reference utterance 302 may include “the quick brown fox jumps over the lazy dog,” which is spoken by the reference speaker. The reference utterance 302 may include non-synthetic speech (e.g., human speech) or synthetic speech. Each input text sequence 304 corresponds to one of the reference utterances 302 and includes a corresponding transcript 306 for each of the plurality of terms of the reference utterance 302 spoken by the reference speaker. That is, the input text sequence 304 includes corresponding transcripts 306 for each word or term spoken in the reference utterance 302. As such, the input text sequence 304 directly corresponds to the reference utterance 302. Moreover, the speech resynthesis process 300 obtains a speaker embedding 308 characterizing speaker characteristics of the reference speaker that spoke the plurality of terms. The speaker embedding 308 is a multi-dimensional representation that captures various attributes of the voice of the reference speaker, such as intonation, language, prosody, pitch, tone, and speaking style. As will become apparent, these attributes may be leveraged to generate synthetic speech generated later in the process that closely matches the natural speech patterns of the reference speaker.

The augmentation model 310 obtains each input text sequence 304, which includes the transcripts 306 for each of the plurality of terms, and generates a replacement input text sequence 314 by manipulating the input text sequence 304. Here, the manipulation may include replacing the corresponding transcript 306 of a respective one of the plurality of terms with a replacement transcript 316 corresponding to a different term not included in the reference utterance 302. For example, if the input text sequence 304 is “the quick brown fox jumps over the lazy dog,” the augmentation model 310 may replace the transcript corresponding to the term “fox” with a replacement transcript 316 corresponding to the term “cat.” The manipulation may also include inserting, deleting or modifying words or phrases within the input text sequence 304. For instance, the augmentation model 310 may insert the word “very” before “quick,” resulting in “the very quick brown fox jumps over the lazy dog.” Alternatively, the augmentation model may delete the word “the” before “lazy,” resulting in “the quick brown fox jumps over lazy dog.” The replacement, insertion, deletion, or modification process introduces variability into the training data, which is beneficial for creating a more robust ASR model 200. For instance, continuing from the previous example, the augmentation model 310 may replace the transcript 306 of the term “fox” with the replacement transcript 316 of the term “cat,” resulting in the replacement input text sequence 314 of “the quick brown cat jumps over the lazy dog.”

In some examples, the different term includes a speech disfluency term. A speech disfluency term refers to any interruption in the normal flow of speech, such as fillers (e.g., “um,” “uh”), repetitions (e.g., “I-I-I), or corrections. The speech disfluency term may replace one of the terms within the input text sequence 304 or be added to the input text sequence 304. Including such terms may help the ASR model 200 better handle real-world speech patterns, which often include these speech disfluencies. For example, the augmentation model 310 may insert the filler “um” before the word “fox,” resulting in “the quick brown um fox jumps over the lazy dog.” Or, the augmentation model 310 may replace the word “fox” with the repetition “f-f-fox,” resulting in “the quick brown f-f-fox jumps over the lazy dog.” As another example, the augmentation model may insert a correction, changing “the quick brown fox” to “the quick brown, I mean, the quick red fox jumps over the lazy dog.” The speech disfluency terms may be added to the input text sequence 304 in addition to, or in lieu of, replacing transcripts 306. For example, the augmentation model 310 may replace “fox” with “cat” and insert the filler term “uh” before “cat,” yielding “the quick brown uh cat jumps over the lazy dog.”

In some implementations, the augmentation model 310 samples the different term from a different speech domain than a speech domain associated with the reference utterance 302. Sampling from a different speech domain refers to selecting terms that are used in different contexts or environments. For example, if the reference utterance 302 is from a formal speech domain, the different term may be sampled from a casual speech domain, technical jargon domain, or another distinct context. Thus, sampling from different speech domains ensures that the ASR model 200 is exposed to a wide range of vocabulary and speech styles, enhancing the ability of the ASR model 200 to generalize across various speech types. For instance, if the reference utterance 302 is “Good evening, ladies and gentleman,” from a formal context, the augmentation model 310 may replace the terms “ladies and gentlemen” with “folks” from a casual context, resulting in “Good evening, folks.”

The speech resynthesis process 300 then conditions the TTS model 130 on the reference utterance 302 and the speaker embedding 308. Specifically, “conditioning” refers to the process of providing these inputs to the TTS model 130 so that the TTS model 130 takes the inputs into account when generating speech. Conditioning may be achieved through various techniques, such as feeding the reference utterance 302 and speaker embedding 308 as input features to the model, or by using techniques such as attention mechanisms to allow the TTS model 130 to focus on relevant aspects of these inputs. By conditioning the TTS model 130 on these inputs, the speech resynthesis process 300 ensures that the TTS model 130 generates speech that not only matches the replacement input text sequence 314 but also retains the unique vocal characteristics of the reference speaker. That is, the speech will sound like it was spoken by the reference speaker even though the words have been changed. In fact, the reference speaker may have never spoken the changed words. Thereafter, the conditioned TTS model 130 generates resynthesized speech 134 based on the replacement input text sequence 314 in the voice of the reference speaker. Continuing with the example above, the conditioned TTS model 130 generates resynthesized speech 134 that produces a new audio segment in the voice of the reference speaker that says, “The quick brown cat jumps over the lazy dog.” Notably, the reference speaker never spoke the entire utterance of the resynthesized speech 134 (e.g., the reference speaker never spoke “cat”), yet the resynthesized speech 134 is in the voice of the reference speaker. Accordingly, the speech resynthesis process 300 ensures that the synthetic speech data is both diverse in context and consistent in speaker characteristics, which is important for training ASR models 200 to handle real-world speech variability effectively.

In some implementations, the respective one of the plurality of terms includes a first hotword and the different term includes a second hotword different than the first hotword. A hotword is a keyword or phrase that activates a specific function or response by the ASR model 200. The replacement process is particularly useful for training ASR models 200 to recognize and respond to various hotwords, thereby enhancing the flexibility and robustness of the ASR models 200. For example, the reference utterance 302 may include “Hey Google.” Here, the augmentation model 310 may replace the term “Google” with the term “Pixel” to create the replacement input text sequence 312 of “Hey Pixel.” The variation produced by the replacement input text sequence 312 allows the ASR model 200 to learn and adapt to different hotwords. Moreover, this approach may be extended to other hotwords and phrases, enabling the creation of a diverse set of training data that better represents the range of user interactions with the ASR model 200.

Optionally, the speech resynthesis process 300 may employ a post-processing module 320 to post-process the resynthesized speech 134 to enhance the quality and naturalness of the resynthesized speech 134. The post-processing module 320 may perform several functions to refine the resynthesized speech 134 and generate post-processed resynthesized speech 324. Alternatively, the post-processing module 320 may perform functions to refine the voice cloned resynthesized speech 136 to generate the post-processed resynthesized speech 324. Firstly, the post-processing module 320 analyzes the resynthesized speech 134 in conjunction with the reference utterance 302 to identify and preserve audio segments that are common to both the reference utterance 302 and the resynthesized speech 134. As such, the post-processing module 320 ensures that terms present in both the resynthesized speech 134 and the reference utterance 302 retain the acoustic properties of the reference utterance 302, thereby maintaining the naturalness and consistency of the voice of the reference speaker. Post-processing the resynthesized speech may include at least one of applying cross-fading, force alignment, or time dynamic warping to the resynthesized speech 134. In some implementations, the post-processing module 320 may employ a combination of these techniques.

Cross-fading helps in smoothing transitions between audio segments by gradually blending the end of one segment with the beginning of the next segment, which minimizes abrupt changes and creates a more natural flow. Force alignment ensures precise synchronization of phonetic elements by aligning the phonetic transcription of the resynthesized speech 134 with the reference utterance 302, ensuring that each phoneme is accurately timed. The use of force alignment and cross-fading as a post-processing step may fully preserve original waveform samples of specific words. For example, given the reference utterance 302 of “Hey Google, what is the time?” and the resynthesized speech 134 of “Hey Gemini, what is the time?” force alignment may be used to get the timing information of each word, and only the edited word (“Google”) is replaced with (“Gemini”), while cross-fading is applied near word boundaries. In this approach, the audio waveform of the words “Hey” and the query (i.e., “What's the time”) are fully preserved.

Dynamic time warping (DTW) adjusts the timing of speech to match natural speaking patterns by stretching or compressing the time axis of the resynthesized speech 134 to align with the reference utterance 302, ensuring that the rhythm and tempo closely match. In some examples, DTW may be used to partially preserve original waveform samples of specific words. For example, given the original “Hey Google”+Query utterance and the new synthesized “Hey Gemini”+Query utterance, DTW can be applied on a feature space (e.g., waveform, MFCC, log-mel filterbank energies, or F0) between the two utterances. Based on the DTW alignment, some of the synthesized samples may be replaced by the corresponding original samples, or a weighted average of the synthesized and original samples are used. Thus, the post-processing module 320 produces post-processed resynthesized speech 324 that is not only diverse in content but also high in quality, closely matching the nuances of real-world speech. For example, if the original resynthesized speech 134 has abrupt transitions between words, cross-fading will smooth these transitions. If the timing of phonemes is slightly off, force alignment will correct the timing. If the overall tempo of the speech feels unnatural, dynamic warping will adjust the resynthesized speech 134 to sound more natural.

In some configurations, the speech resynthesis process 300 includes a modifier 330 that is configured to modify the replacement transcript 316 of the different term from the replacement input text sequence 312. That is, the modifier 330 generates an updated replacement input text sequence 334 by replacing the replacement transcript 316 with the modified replacement transcript 336. The modification process introduces additional variability into the synthetic speech data. For example, if the replacement input text sequence 314 is “Hey Pixel,” the modifier 300 may update the replacement input text sequence 334 to “Hey, Pixel!” or “Hey, Pix-el,” or “Heh Peexel,” “Hey, Hey Pixel,” “Hey Pixl,” “Hey; Pixel,” or “Hey uh Pixel.” Thereafter, the TTS model 130, conditioned on the reference utterance 302 and the speaker embedding 308, generates additional resynthesized speech 134 based on the updated replacement input text sequence 332 in the voice of the reference speaker. The iterative process of modifying and resynthesizing speech ensures that the speech data encompasses a wide range of vocabulary and sentence structures, while retaining the unique vocal characteristics of the reference speaker. In some embodiments, the resynthesized speech 134 based on certain modified replacement input text sequences 334, such as “Hey tickle” in the current example, may be labeled as negative examples for training a hotword or keyword model.

The modifier 330 may also alter the pronunciation of syllables, for example, changing “Hey Pixel” to “Heh Peexel.” In some implementations, the text prompt variations are identified using a pronunciation lexicon, which specifies how words are pronounced. All the pronunciations of the target keyword are found, and then the lexicon searches to find words that have similar pronunciations. The modifier 330 uses these words, including variations with different spellings and pronunciations, to create the modified replacement transcript 336. In other embodiments, a large language model is used to identify the text prompt variations. The large language model may be prompted with the target keyword and asked to generate a list of spelling variations, pronunciation variations, and/or other text prompt variations. The large language model may also be prompted to generate negative examples, such as close-sounding phrases that are not keyword triggers. For example, the large language model may be prompted with the target keyword “Hey Pixel” and asked to generate a list of spelling variations, such as “Hey Pixl,” “Hey, Pixel,” and “Hey; Pixel.” The large language model may also be prompted to generate pronunciation variations, such as “Heh Peexel” and “Hey, um, Pixel.” Additionally, the large language model may be prompted to generate negative examples, such as “Hey tickle” and “Hey pickle.” The large language model may also be prompted to generate text prompt variations that are not spelling or pronunciation variations, such as “Hey, what's up Pixel?” and “Hey Pixel, how's it going?”

The modifier 330 may alter the replacement transcript 316 in several ways to create the updated replacement input text sequence 332. These modifications may include at least one of modifying syllables of the replacement transcript, modifying punctuation of the replacement transcript, or inserting a speech disfluency into the replacement transcript. For example, the modifier 330 may insert additional syllables into the replacement input text sequence 312 of “Hey Pixel,” resulting in “Hey Hey Pixel.” Alternatively, the modifier 330 may delete syllables, changing “Hey Pixel” to Hey Pixl.” The modifier 330 may also adjust punctuation of the replacement input text sequence 312, transforming “Hey Pixel” into “Hey, Pix-el.” Additionally or alternatively, the modifier 330 may insert speech disfluencies, such as stutters or filler words, to make the synthetic speech sound more natural and varied. For instance, the modifier 330 may modify the replacement input text sequence 312 of “Hey Pixel” to “Hey, um, Pixel.”

In some examples, the modifier 330 generates an augmented speaker embedding 338 that augments at least one of the speaker characteristics of the reference speaker that spoke the plurality of terms. The augmentation process involves altering specific attributes of the speaker embedding 308. These attributes may include pitch, tone, prosody, or other vocal characteristics of the voice of the reference speaker. For instance, the augmented speaker embedding 338 may adjust the intonation patterns to make the speech sound more formal or casual, or adjust the prosody to emphasize different parts of the speech. The modification process may also include changing the speaker identity by utilizing a target SpeakerId, resulting in synthesized speech with the characteristics of the target speaker. Similarly, the LanguageId may be modified to generate speech with a foreign accent, where the reference speaker's characteristics are retained but the pronunciation follows the rules of the target language.

Moreover, prosodic characteristics such as durations, broad timing, local timing, and pitch inflection may be controlled to generate speech that is distinct from the reference audio, while maintaining correspondence to various high or low-level attributes. Thereafter, the speech resynthesis process 300 may condition the TTS model 130 on the augmented speaker embedding 338 in addition to, or in lieu of, the speaker embedding 308. By conditioning the TTS model 130 on the augmented speaker embeddings 338, the TTS model may generate a wider range of synthetic speech outputs that still sound like the reference speaker but exhibit different vocal characteristics. In some implementations, the modifier 330 simultaneously controls the speaker characteristics, prosodic characteristics, and/or lexical content to generate speech that is distinct from the reference audio in predictable ways. This allows for manipulation of the spoken words, accent, speaker identity, timing, and/or pitch.

The TTS model 130 may be further conditioned on the modified speaker embedding 338. As such, the conditioned TTS model 130 generates additional resynthesized speech 134 that includes synthesized speech corresponding to the replacement input text sequence 314, but now incorporates the voice of the reference speaker with the augmented at least one of the speaker characteristics of the augmented speaker embedding 338. For example, if the original speaker embedding represents a calm and steady speaking style, the augmented speaker embedding 338 may introduce a more dynamic and expressive style, resulting in additional resynthesized speech 134 that sounds more animated while still being recognizable as the voice of the reference speaker. Another example may be if the original speaker embedding 308 has a formal tone, the augmented speaker embedding 338 may be modified to sound more casual and conversational. This flexibility allows the synthetic speech to be tailored to different scenarios and user interactions, making the speech more versatile for various applications. The conditioned TTS model 130 may also generate additional resynthesized speech 134 based on the modified replacement input text sequence 334 whereby the TTS model 130 is conditioned on the reference utterance 302 and the speaker embedding 308 or augmented speaker embedding 338.

In some implementations, the speech resynthesis process 300 employs a voice cloning model 340 configured to clone the voice of a different speaker that has different speech characteristics than the reference speaker. Here, the voice cloning model 340 receives an audio signal 301 that includes one or more other terms spoken by the different speaker. The voice cloning model 340 generates a voice cloned reference utterance 342 based on the reference utterance 302 and the audio signal 301. Here, the voice cloned reference utterance 342 includes synthesized speech corresponding to the input text sequence 304 in a voice of the different speaker. Thus, the speech resynthesis process 300 may condition the TTS model 130 further on the voice cloned reference utterance 342 in addition to, or in lieu of, the reference utterance 302. Here, the conditioned TTS model 130 generates voice cloned resynthesized speech 136 based on the replacement input text sequence 314. For example, if the replacement input text sequence 314 is “jumping over the lazy dog,” and the TTS model 130 is conditioned on the voice cloned reference utterance 342, then the voice cloned reference utterance 342, then the voice cloned resynthesized speech 136 will be a synthesized version of “jumping over the lazy dog” spoken in the voice of the target speaker. The voice cloned resynthesized speech 136 includes synthesized speech corresponding to the replacement input text sequence 314 in the voice of the different speaker.

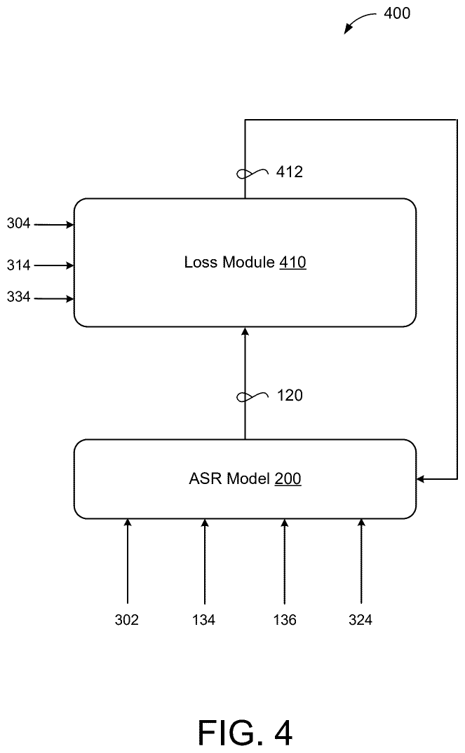

FIG. 4 illustrates a training process 400 for training the ASR model 200. The training process 400 obtains a plurality of reference utterances 302 and a plurality of input text sequences 304. Here, each reference utterance 302 corresponds to one of the input text sequences 304. That is, each reference utterance 302 is paired with one of the input text sequences 304. For example, a reference utterance 302 might be an audio recording of the phrase “the quick brown fox” spoken by a specific individual, and the corresponding input text sequence 304 would be “the quick brown fox.” Moreover, the training process 400 obtains the resynthesized speech 134 paired with the replacement input text sequence 314 or the updated replacement input text sequence 334. The training process 400 may also obtain voice cloned resynthesized speech 136 paired with the replacement input text sequence 314. Additionally or alternatively, the training process 400 may obtain the post-processed resynthesized speech 324 paired with the replacement input text sequence 314 or the updated replacement input text sequence 334. For each speech input (e.g., reference utterance 302, resynthesized speech 134, voice cloned resynthesized speech 136, post-processed resynthesized speech 324), the ASR model 200 processes the speech input to generate a corresponding transcription 120. For instance, if the speech input is the reference utterance 302 “the quick brown fox,” the ASR model 200 would ideally generate the transcription 120 “the quick brown fox.” However, during training, the transcription 120 generated by the ASR model 200 may be incorrect, such as “the quick brown focks” or “the quik brown fox.”

Thereafter, a loss module 410 determines a loss 412 by comparing the transcription 120 to the corresponding input text sequence 304, replacement input text sequence 314, or the updated replacement input text sequence 334. For example, the loss module 410 compares the transcription 120 of “the quick brown focks” to the correct input text sequence 304, replacement input text sequence 314, or the modified replacement input text sequence 334 corresponding to “the quick brown fox” and determines a loss value reflecting the difference. The training process 400 trains the ASR model 200 on the loss 412 by updating parameters of the ASR model 200. Thus, the training process 400 trains the ASR model 200 on various speech inputs, such as the reference utterances 302, resynthesized speech 134, voice cloned resynthesized speech 136, and the post-processed resynthesized speech 324. After the training process 400 trains the ASR model 200, the trained ASR model 200 may obtain an utterance 106 and generate a transcription 120 for the utterance 106. In some implementations, the ASR model 200 includes a hotword model such that the training process trains the hotword model on the resynthesized speech 134.

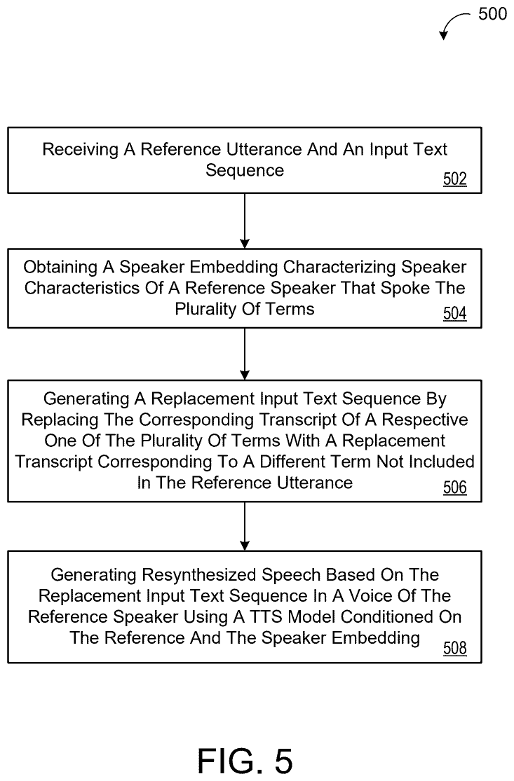

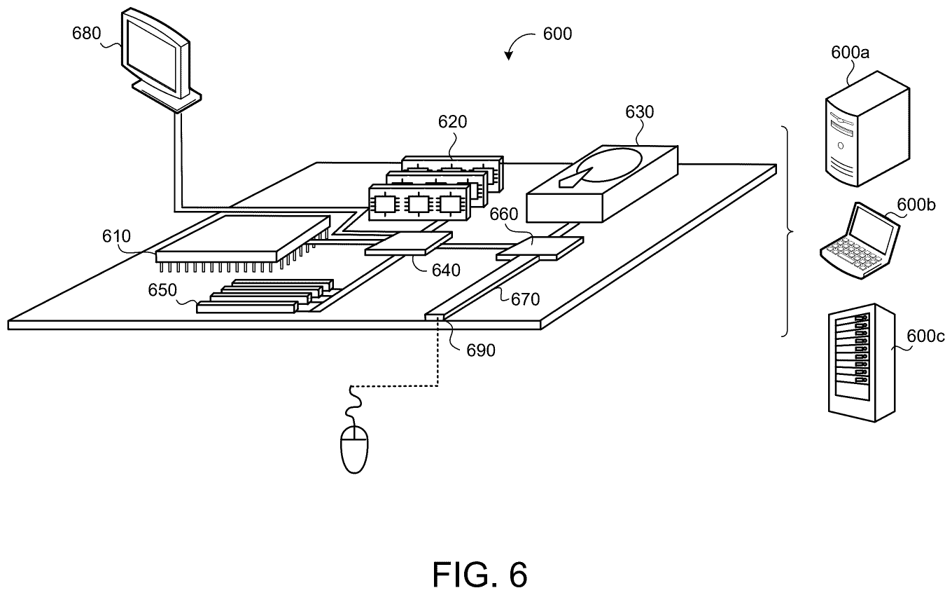

FIG. 5 is a flowchart of an example arrangement of operations for a computer-implemented method 500 of speech-text prompting for speech tasks. The method 500 may execute on data processing hardware 610 (FIG. 6) using instructions stored on memory hardware 620 (FIG. 6). The data processing hardware 610 and the memory hardware 620 may reside on the user device 102 and/or the remote computing device 201 of FIG. 1 each corresponding to a computing device 600 (FIG. 6).

At operation 502, the method 500 includes receiving a reference utterance 302 and an input text sequence 304. The reference utterance 302 includes a plurality of terms spoken by a reference speaker. The input text sequence 304 includes a corresponding transcript 306 for each of the plurality of terms spoken by the reference speaker. At operation 504, the method 500 includes obtaining a speaker embedding 308 characterizing speaker characteristics of the reference speaker that spoke the plurality of terms. At operation 506, the method 500 includes generating a replacement input text sequence 314 by replacing the corresponding transcript 306 of a respective one of the plurality of terms with a replacement transcript 316 corresponding to a different term not included in the reference utterance 302. At operation 508, the method 500 includes generating, using a TTS model 130 conditioned on the reference utterance 302 and the speaker embedding 308, resynthesized speech 134 based on the replacement input text sequence 314 in a voice of the reference speaker.

FIG. 6 is a schematic view of an example computing device 600 that may be used to implement the systems and methods described in this document. The computing device 600 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 600 includes a processor 610, memory 620, a storage device 630, a high-speed interface/controller 640 connecting to the memory 620 and high-speed expansion ports 650, and a low speed interface/controller 660 connecting to a low speed bus 670 and a storage device 630. Each of the components 610, 620, 630, 640, 650, and 660, are interconnected using various busses, and may be mounted on a common motherboard or in other manners as appropriate. The processor 610 can process instructions for execution within the computing device 600, including instructions stored in the memory 620 or on the storage device 630 to display graphical information for a graphical user interface (GUI) on an external input/output device, such as display 680 coupled to high speed interface 640. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 620 stores information non-transitorily within the computing device 600. The memory 620 may be a computer-readable medium, a volatile memory unit(s), or non-volatile memory unit(s). The non-transitory memory 620 may be physical devices used to store programs (e.g., sequences of instructions) or data (e.g., program state information) on a temporary or permanent basis for use by the computing device 600. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 630 is capable of providing mass storage for the computing device 600. In some implementations, the storage device 630 is a computer-readable medium. In various different implementations, the storage device 630 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 620, the storage device 630, or memory on processor 610.

The high speed controller 640 manages bandwidth-intensive operations for the computing device 600, while the low speed controller 660 manages lower bandwidth-intensive operations. Such allocation of duties is exemplary only. In some implementations, the high-speed controller 640 is coupled to the memory 620, the display 680 (e.g., through a graphics processor or accelerator), and to the high-speed expansion ports 650, which may accept various expansion cards (not shown). In some implementations, the low-speed controller 660 is coupled to the storage device 630 and a low-speed expansion port 690. The low-speed expansion port 690, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 600a or multiple times in a group of such servers 600a, as a laptop computer 600b, or as part of a rack server system 600c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
receiving a reference utterance and an input text sequence, the reference utterance comprising a plurality of terms spoken by a reference speaker and the input text sequence comprising a corresponding transcript for each of the plurality of terms spoken by the reference speaker;
obtaining a speaker embedding characterizing speaker characteristics of the reference speaker that spoke the plurality of terms;
generating a replacement input text sequence by replacing the corresponding transcript of a respective one of the plurality of terms with a replacement transcript corresponding to a different term not included in the reference utterance; and
generating, using a text-to-speech (TTS) model conditioned on the reference utterance and the speaker embedding, resynthesized speech based on the replacement input text sequence in a voice of the reference speaker.

2. The computer-implemented method of claim 1, wherein the operations further comprise:
receiving an audio signal comprising one or more other terms spoken by a different speaker;
generating, using a voice cloning model, a voice cloned reference utterance based on the reference utterance and the audio signal, the voice cloned reference utterance comprising synthesized speech corresponding to the input text sequence in a voice of the different speaker; and
generating, using the TTS model further conditioned on the voice cloned reference utterance, voice cloned resynthesized speech based on the replacement input text sequence, the voice cloned resynthesized speech comprising synthesized speech corresponding to the replacement input text sequence in the voice of the different speaker.

3. The computer-implemented method of claim 1, wherein the respective one of the plurality of terms comprises a first hotword and the different term comprises a second hotword different than the first hotword.

4. The computer-implemented method of claim 3, wherein the operations further comprise training a hotword model on the resynthesized speech.

5. The computer-implemented method of claim 1, wherein the operations further comprise training a speech recognition model on the reference utterance paired with the input text sequence and the resynthesized speech paired with the replacement input text sequence.

6. The computer-implemented method of claim 1, wherein the different term comprises a speech disfluency term.

7. The computer-implemented method of claim 1, wherein the different term is sampled from a different speech domain than a speech domain associated with the reference utterance.

8. The computer-implemented method of claim 1, wherein the operations further comprise post-processing the resynthesized speech based on the reference utterance to preserve audio from the reference utterance for terms included in the resynthesized speech and the reference utterance.

9. The computer-implemented method of claim 8, wherein post-processing the resynthesized speech comprises at least one of:
cross-fading;
force alignment; or
dynamic time warping.

10. The computer-implemented method of claim 1, wherein the operations further comprise:
modifying the replacement transcript of the different term from the replacement input text sequence; and
generating an updated replacement input text sequence by replacing the replacement transcript with the modified replacement transcript; and
generating, using the TTS model conditioned on the reference utterance and the speaker embedding, additional resynthesized speech based on the updated replacement input text sequence in the voice of the reference speaker.

11. The computer-implemented method of claim 10, wherein modifying the replacement transcript of the different term from the replacement input text sequence comprises at least one of:
modifying syllables of the replacement transcript;
modifying punctuation of the replacement transcript; or
inserting a speech disfluency into the replacement transcript.

12. The computer-implemented method of claim 1, wherein the operations further comprise:
generating an augmented speaker embedding that augments at least one of the speaker characteristics of the reference speaker that spoke the plurality of terms; and
generating, using the TTS model further conditioned on the augmented speaker embedding, additional resynthesized speech comprising synthesized speech corresponding to the replacement input text sequence in the voice of the reference speaker with the augmented at least one of the speaker characteristics.

13. A system comprising:
data processing hardware; and
memory hardware in communication with the data processing hardware, the memory hardware storing instructions that when executed on the data processing hardware cause the data processing hardware to perform operations comprising:
receiving a reference utterance and an input text sequence, the reference utterance comprising a plurality of terms spoken by a reference speaker and the input text sequence comprising a corresponding transcript for each of the plurality of terms spoken by the reference speaker;
obtaining a speaker embedding characterizing speaker characteristics of the reference speaker that spoke the plurality of terms;
generating a replacement input text sequence by replacing the corresponding transcript of a respective one of the plurality of terms with a replacement transcript corresponding to a different term not included in the reference utterance; and
generating, using a text-to-speech (TTS) model conditioned on the reference utterance and the speaker embedding, resynthesized speech based on the replacement input text sequence in a voice of the reference speaker.

14. The system of claim 13, wherein the operations further comprise:
receiving an audio signal comprising one or more other terms spoken by a different speaker;
generating, using a voice cloning model, a voice cloned reference utterance based on the reference utterance and the audio signal, the voice cloned reference utterance comprising synthesized speech corresponding to the input text sequence in a voice of the different speaker; and
generating, using the TTS model further conditioned on the voice cloned reference utterance, voice cloned resynthesized speech based on the replacement input text sequence, the voice cloned resynthesized speech comprising synthesized speech corresponding to the replacement input text sequence in the voice of the different speaker.

15. The system of claim 13, wherein the respective one of the plurality of terms comprises a first hotword and the different term comprises a second hotword different than the first hotword.

16. The system of claim 15, wherein the operations further comprise training a hotword model on the resynthesized speech.

17. The system of claim 13, wherein the operations further comprise training a speech recognition model on the reference utterance paired with the input text sequence and the resynthesized speech paired with the replacement input text sequence.

18. The system of claim 13, wherein the different term comprises a speech disfluency term.

19. The system of claim 13, wherein the different term is sampled from a different speech domain than a speech domain associated with the reference utterance.

20. The system of claim 13, wherein the operations further comprise post-processing the resynthesized speech based on the reference utterance to preserve audio from the reference utterance for terms included in the resynthesized speech and the reference utterance.

21. The system of claim 20, wherein post-processing the resynthesized speech comprises at least one of:
cross-fading;
force alignment; or
dynamic time warping.

22. The system of claim 13, wherein the operations further comprise:
modifying the replacement transcript of the different term from the replacement input text sequence; and
generating an updated replacement input text sequence by replacing the replacement transcript with the modified replacement transcript; and
generating, using the TTS model conditioned on the reference utterance and the speaker embedding, additional resynthesized speech based on the updated replacement input text sequence in the voice of the reference speaker.

23. The system of claim 22, wherein modifying the replacement transcript of the different term from the replacement input text sequence comprises at least one of:
modifying syllables of the replacement transcript;
modifying punctuation of the replacement transcript; or
inserting a speech disfluency into the replacement transcript.

24. The system of claim 13, wherein the operations further comprise:
generating an augmented speaker embedding that augments at least one of the speaker characteristics of the reference speaker that spoke the plurality of terms; and
generating, using the TTS model further conditioned on the augmented speaker embedding, additional resynthesized speech comprising synthesized speech corresponding to the replacement input text sequence in the voice of the reference speaker with the augmented at least one of the speaker characteristics.
